(19) United States
(12) Patent Application Publication
(10) Pub. No.: US 2011/0220425 A1
(43) Pub. Date: Sep. 15, 2011

(54) WEIGHING SCALE

(75) Inventors: Andre DENK, Essen (DE); Pedro Stange, Dietz (DE); Christian Moddick, Drensteinfuhrt (DE); Artjom Emter, Koblenz (DE); Kristian Schiebor, Koblenz (DE)

(73) Assignee: LEIFHEIT AG

(21) Appl. No.: 13/041,890

(22) Filed: Mar. 7, 2011

(30) Foreign Application Priority Data
Mar. 9, 2010 (DE) 10 2010 011 032.9
Feb. 10, 2011 (DE) 10 2011 000 648.6

(51) Int. Cl. G01G 7/00

(52) U.S. Cl. 177/210 R

(57) ABSTRACT

The invention relates to a weighing scale comprising a base plate and a load plate on which the object to be weighed is placed or on which the person to be weighed stands. At least three planar load cells are arranged between load plate and base plate which load cells are fastened to the load plate and are loosely supported on elevations of the base plate.

The invention relates to a weighing scale with a load plate, a base plate arranged below the load plate and load cells which are formed by a bending element with a first load-side fastening portion and a second bottom-side fastening portion which are connected with each other via at least one deformation portion which comprises means for measuring the deflection of the deformation portion as a result of a load to be weighted being placed on the load plate, wherein the means for measuring the deflection of the deformation portion are capable of passing the measured value to evaluation electronics capable of calculating a weight to be measured from the deflection of the deformation portions of the load cells and of outputting it via an indicating device.

Weighing scales such as bathroom scales and kitchen scales with load cells have been known from the state of the art for a long time. With these scales the load cells are arranged between a load plate onto which the object to be weighed is placed or on which the person to be weighed stands, and a base plate which is placed onto the ground for the measuring operation. In this known weighing scale the load cell is a double bending beam load cell arranged in the centre of the scale.

Using double bending beam load cells has the advantage that these can compensate for a falsification of the measuring result due to a torque and that only one double bending beam load cell has to be used in order to obtain an exact measuring result. A torque falsifying a measuring result is created if, for example, the object to be weighed is not arranged in the centre of the scale. The torque increases with the distance by which the spot onto which the object to be weighed is placed is spaced from the centre of the scale in which the double bending beam load cell is arranged.

A weighing scale using a double bending beam load cell is disclosed in DE 103 08 803, for example. Specifically this scale uses only one double bending beam load cell which is arranged in the centre of the scale.

The disadvantage with using double bending beam load cells is that due to the structure of the double bending beam load cell the distance between load plate and the base plate is relatively large which means that the scale is of considerable constructional height. The constructional height is further increased in scales, which have support feet arranged on the base plate. Due to the considerable constructional height of the scales it is difficult to stow them away and there is an increased risk of tripping.

The EP 0 505 493 B1 discloses load cells of the kind mentioned in the beginning comprising a load-side fastening portion and a second bottom-side fastening portion which are connected with each other by at least one deformation portion. Normally these are formed from a flat plane metal piece, wherein, for example, the load-side fastening portion and the bottom-side fastening portion are formed in a U-shape around the deformation portion with a gap left in the centre, but other shapes are also possible and are used. The EP 0 505 493 B1 also discloses a weighing scale equipped with these load cells which are called planar load cells in the following.

A further weighing scale with planar load cells is known from the WO 95/31700 A1. This weighing scale exhibits the features of the weighing scale mentioned in the beginning, wherein the load cells are firmly connected to the load plate and to feet in the base plate. The bottom-side fastening portion is provided here with a fixing hole into which the elastic foot passing through the base plate is lockingly inserted.

The disadvantage with the state of the art is that a certain constructional height is required and/or that there is a risk of a frictional connection with the base plate which might lead to measuring inaccuracies.

It is the object of the invention to provide a weighing scale having a small constructional height and where the previously mentioned torque does not falsify the measuring results.

This object is achieved by a scale according to claim 1. Advantageous embodiments of the invention are defined in the sub-claims.

The invention has the advantage that at least three planar load cells are arranged in the weighing scale between load plate and base plate. The planar load cells are of a small constructional height resulting in a small distance between load plate and base plate. As a result, the constructional height of the scale is reduced in comparison to scales in which a double bending beam load cell is used. Due to the small constructional height of the scale new possibilities arise for stowing the same away. Thus it is possible, for example, to integrate the scale with a carpet or the like.

In addition the scale according to the invention has the advantage that at least three planar load cells are provided. Since at least three planar load cells are provided, it is automatically understood that these are always arranged closer to a respective end face or to the edge of the scale than the centrally disposed double bending beam load cell. For this reason the torque created when applying a load to an end face of the scale is smaller than with known scales. Specifically the torque is of such a small size that the measuring results obtained are sufficiently accurate.

Further, the invention has the advantage that the base plate is of a planar and elastic construction and therefore has no unevennesses which could arise, for example, if support feet were provided. The advantage of the planar base plate consists in that for a measuring operation the force introduced into the scale covers the entire surface of the base plate which faces the ground. Thus there is no possibility of a secondary frictional force arising which would falsify the measuring result since in contrast to the known scales in which support feet are employed all forces introduced into the base plate are passed onto the load cell.

A further advantageous design of the invention consists in that each of the planar load cells is provided on end faces of the scale which differ from each other. Such an arrangement of the planar load cells improves the accuracy of the measuring results since the influence of the torque upon the measuring accuracy is reduced due to the fact that the distance between an introduction of force through an object to be weighed or the person to be weighed and the position of the planar load cell closest to the object or the person is small.

Further, an advantageous design of the invention consists in that several segments each comprising at least three planar load cells are provided. Provision of several segments and thus several planar load cells has the advantage that in a weighing operation the load is distributed among several segments or planar load cells. Thus the force acting upon one planar load cell is also reduced in comparison to scales having only three planar load cells. As a result planar load cells of a smaller constructional height can be used which reduces the constructional height of the weighing scale as a whole. A further advantage of using several segments consists in that the influence of the torque upon the measuring accuracy is further lessened since the distance between the object or the person and the planar load cell closest to it is further reduced.

An essential feature of the present invention is the fact that it is possible to design the scale to be ultra-flat. This means for example that a height of 6-16 mm, in particular, for the scale is possible. The essential component of this weighing scale is a flexible base plate which, in particular, can be given a tray-like shape in order to surround and enclose the internals of the scale, i.e. the load cells and the evaluation electronics thereby preventing the ingress of dirt. The load plate on which the load to be weighed is placed is arranged above this base plate. The load plate is then provided with load cells and for this purpose comprises receiving means thereby allowing the load cell to be fastened to the underside of the load plate using the load-dependent fastening portion.

Receiving means for fastening the load cells may be either screw connections or plug-in possibilities into which the load cells can be pushed so that a downward facing undercut is able to retain the load cells in a downward direction. Also spring clips or other clamping brackets may be used as receiving means. In this way the load cell is firmly connected to the load plate with the load-side fastening portion.

The deformation portion of the load cell is disposed in the load-side fastening portion with the deformation portion in turn ending in the bottom-side fastening portion. The deformation portion is provided with one or more strain gauges the strain of which can be ascertained by measuring the resistance thereby enabling the evaluation electronics to ascertain the deformation of the load cell, frequently also called planar load cell, and to convert, based on this deformation, the load on the load plate into a weight. All signals of the load cells used, four signals as a rule, are used for calculating the overall result.

The bottom-side fastening portion is not fixedly connected with the base plate, but preferably rests on elevations or on upwardly projecting supports. The fastening portions can be prevented from slipping sidewards via further upwardly projecting elevations or edge constrains resulting in the fastening portion lying in a frame which, on the one hand, gives loose support and on the other hand, is capable of suppressing lateral slipping. Preferably this frame is shaped in such a way as to result in a certain amount of clearance between the bottom-side fastening portion and the frame elements thereby preventing transverse forces from leading to erroneous measuring results.

Preferably the base plate is connected to the load plate via snap connections. In order to be able to replace batteries or to maintain the evaluation electronics these connections may be designed so as to be detachable, but if this is not desirable a connection can be devised which can be undone only by destroying the individual elements of the connection. A battery compartment may also be accessible via an additional battery compartment cover and the same can be provided for the evaluation electronics. Both the evaluation electronics and the battery compartment holder is preferably arranged on the load plate.

The base plate is flexible to the extent where the whole of its area is able to touch the ground leaving only the respective signals at the load transfer to be measured via the load cells. This has the effect of preventing any secondary frictional force from being created which could falsify the measuring result because the deflection paths of the load cells are so long that the usual unevennesses of the ground are not able to generate a secondary frictional force.

The subject of the invention is illustrated in the drawings and will now be described with reference to the figures, wherein identically functioning elements are marked by the same reference symbols and in which

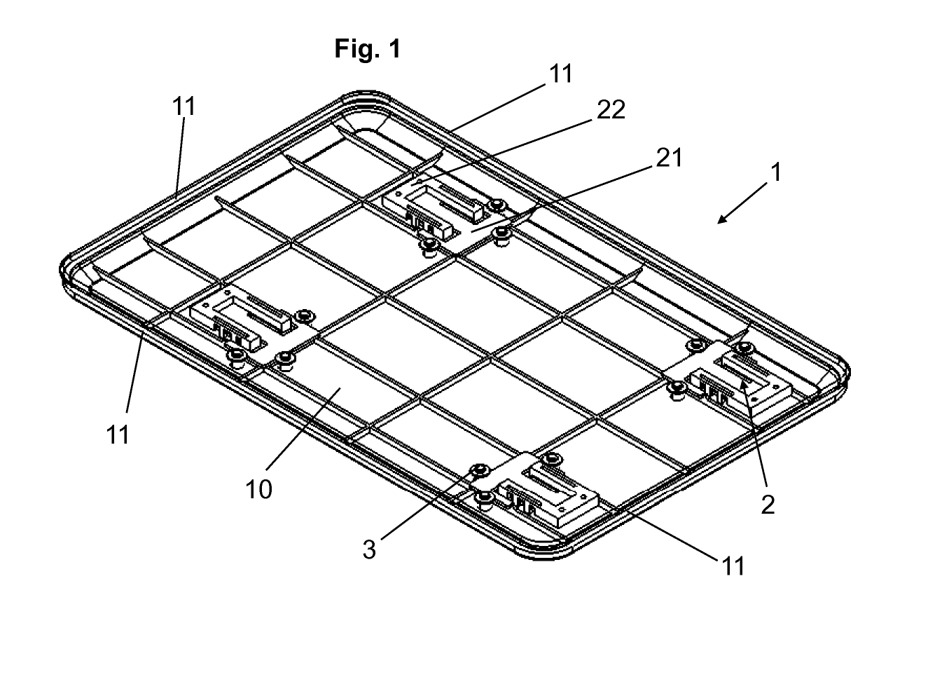

FIG. 1 shows a first embodiment of the load plate of a weighing scale with planar load cells, seen in a view from below and without base plate,

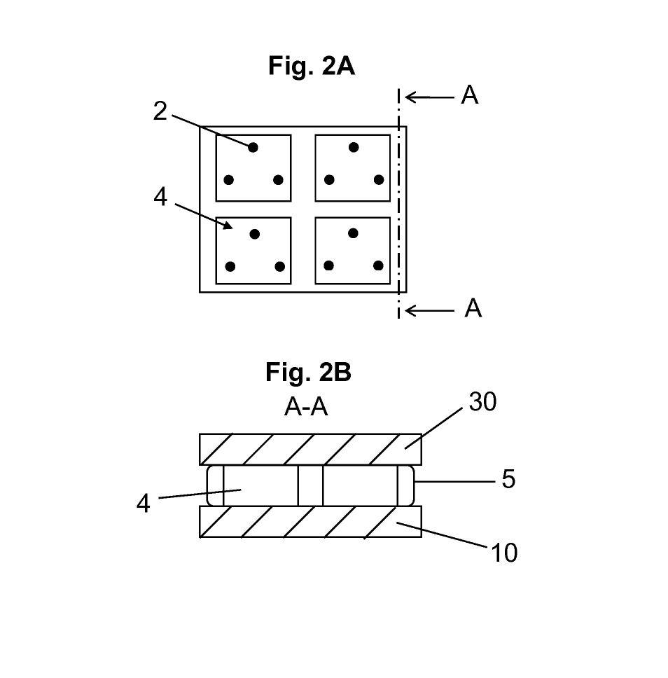

FIG. 2A shows a top view of a schematically drawn scale of a second embodiment comprising several segments, without load plate and base plate,

FIG. 2B shows a section along line A-A of FIG. 2A.

The weighing scale 1 shown in FIG. 1 of a first embodiment has a rectangular load plate 10. Load plate 10 is shaped like the base plate 30 (not shown) in the form of a tray and comprises projections 11 which run along the entire end face of load plate 10. Projections 11 extend in direction of a load plate 10 shown in FIG. 2B, which is placed on top of the tray-shaped base plate 30 resulting in a completely enclosed weighing scale body.

In this embodiment four load cells 2 shaped as planar load cells are arranged on the underside of load plate 10. Embodiments are also feasible in which only three planar load cells or more than four planar load cells are provided. The planar load cells consist of a first bottom-side fastening portion 22 and a second load-side fastening portion 21. The bottom-side fastening portion 22 rests on projections extending upwards from the base plate. The load-side fastening portion 21 is connected in at least one position with the load plate 10 by means of fastening means 3 such as screws or an insertion device behind an undercut.

The individual planar load cells 2 are respectively arranged on end faces of the load plate 10 which are different from one another. Specifically two planar load cells 2 are arranged in two opposite corners. The remaining two planar load cells 2 are respectively arranged between the planar load cell 2 provided in the respective corner and the respectively other corner of load plate 10 in which no planar load cell 2 is provided. Such an arrangement of the planar load cells 2 is intended to prevent falsification of the measuring result if the object to be weighed is placed close to or at the edge of the weighing scale 1 or if the person to be weighed stands close to the edge or at the edge of the weighing scale 1. It is obvious that with an embodiment having only three planar load cells 2 these planar load cells 2 may be arranged at the end faces of load plate 10 and/or at the corners of load plate 10 or in some other form of arrangement.

FIG. 2A shows a top view of a schematically drawn weighing scale 1 in a second embodiment having several segments 4. Segments are considered to be different portions within weighing scale 1 within which at least three planar load cells 2 are arranged. The segments may be of identical size or not.

In this embodiment weighing scale 1 comprises four segments. The planar load cells 2 in each of the segments are arranged in identical positions. To be precise, the individual planar load cells 2 in a single segment 4 are arranged in such a way that the planar load cells 2 are provided in different end areas of segment 4. Embodiments are also feasible in which the planar load cells in individual segments are not always provided in the same position. Furthermore embodiments are feasible in which the planar load cells are not provided in the end areas of segment 4 but in another form of arrangement within the segments.

The segments also permit especially thin and inconspicuous scales to be realised. For example, such segments may be arranged below a carpet, wherein several segments when interconnected make up a weighing scale. The individual segments need not necessarily be linked with one another, rather it is sufficient if the measuring results from the segments are combined with one another in the evaluation electronics and converted to give a total weight.

FIG. 2B shows a sectional view along line A-A of FIG. 2A. The segments 4 and thus the planar load cells 2 are arranged between base plate 30 and load plate 10. The individual segments 4 are connected with each other via a casing 5 consisting of an elastic material. Casing 5 is in contact both with load plate 10 and with base plate 30.

There follows an explanation of the measuring operation. When an object is placed on the edge of load plate 10 or when a person stands on the edge of load plate 10, the load is transferred to the planar load cell 2 which is in contact with load plate 10. As a result the force is transferred to the second fastening portion 22 of planar load cell 2 causing it to bend. By means of a measuring electrics known from the state of the art which comprises a strain gauge provided on planar load cell 2, the amount of bending and thus the weight of the person to be measured or of the object to be measured can be ascertained and output. Since at least three planar load cells 2 are used, which are in contact with load plate 10 in different places, the influence of the occurring torque upon the measuring accuracy is negligible.

A further preferred design of the invention comprises a load plate formed as a minicomputer of the kind currently distributed and normally comprising a touch screen or a normal monitor. This load plate is then able to supply an indication enabling the evaluation electronics, for example, to communicate via a wireless data connection, for example a Bluetooth connection, with the minicomputer and indicate the measuring result on the screen of the minicomputer. Alternatively the load cells themselves may be equipped with a transmitting capability enabling the signal from the load cells to be transmitted to the minicomputer via such a wireless connection thereby enabling the evaluation electronics to be integrated with the minicomputer as well.

In all cases the minicomputer must have means on its underside for fastening the base plate on the one hand and, on the other, for receiving the load cells. In both cases this may be realised by a pocket into which the minicomputer can be inserted and where there is a possibility on the underside of the minicomputer for fastening the load cells and the base plate. Alternatively a frame may be attached to the minicomputer forming the load plate, which on its underside is provided with fastening means for the load cells.

The above mentioned embodiments provide merely examples for the construction of a flat weighing scale with a high measuring accuracy. The principal idea of the invention is, however, not limited by these embodiments.

### LIST OF REFERENCE SYMBOLS

1 weighing scale
10 load plate
11 projection
2 load cell
21 first portion
22 second portion
3 fastening means
30 base plate
4 segment
5 casing

1-16. (canceled)

17. Weighing scale with a load plate, a base plate arranged below the load plate and load cells which are formed by a bending element with a first load-side fastening portion and a second bottom-side fastening portion which are connected with each other via at least one deformation portion which comprises means for measuring the deflection of the deformation portion as a result of a load to be weighted being placed on the load plate, wherein the means for measuring the deflection of the deformation portion are capable of passing the measured value to evaluation electronics which is capable of calculating a weight to be measured from the deflection of the deformation portions of the load cells and of outputting it via an indicating device, wherein the load cells are fastened to the load plate with the load-side fastening portion and rest on supports via the bottom-side fastening portion which supports are facing upwards from the base plate and are capable of supporting the bottom-side fastening portion.

18. Weighing scale according to claim 17, wherein the base plate is formed as a flexible plate, wherein its elasticity is chosen such that the base plate is resting on a ground with support areas arranged below the load cells.

19. Weighing scale according to claim 18, wherein the support areas form a planar underside together with the remaining areas of the base plate.

20. Weighing scale according to claim 17, wherein below the base plate, in particular below the support areas, a thin friction-inhibiting layer is arranged as a standing surface for resting on the ground.

21. Weighing scale according to claim 17, wherein it consists of at least 2 segments of which each is a partial load plate and a partial base plate, each having at least three load cells fastened with load-side fastening portions on the respective partial load plate and resting with bottom-side fastening portions on respective supports, which, starting from the partial base plate, are directed upwards and each being capable of supporting the bottom-side fastening portion, wherein the partial load plates form the load plate and the partial base plates form the base plate and wherein the evaluation electronics is capable, from the loads determined from the loads resting on the partial load plates, of calculating the total weight of the load resting on the load plate formed by the individual partial load plates.

22. Weighing scale according to claim 21, wherein the load cells are arranged at respectively different end areas of segments.

23. Weighing scale according to claim 21, wherein the segments are enclosed by a casing.

24. Weighing scale according to claim 23, wherein the casing consists of a flexible material.

25. Weighing scale according to claim 23, wherein the segments are enclosed by a lower casing forming the base plate and a second upper casing forming the load plate.

26. Weighing scale according to claim 23, wherein the casing is in contact with the base plate and the load plate, in particular encloses the base plate and the load plate.

27. Weighing scale according to claim 17, wherein the load-side fastening element of load cells is screwed to the load plate.

28. Weighing scale according to claim 17, wherein the load cells, with the load-side fastening element, are pushed below undercuts arranged below the load plate.

29. Weighing scale according to claim 17, wherein the load plate is connected with the base plate directly via retaining brackets or other snap-in connections or via the load cells, whereby the connection allows for the freedom of movement necessary for deflecting the load cells.

30. Weighing scale according to claim 29, wherein the load plate is connected with the base plate in such a way that the connection can only be undone by destroying the holding brackets or other snap-connection, wherein the scale comprises at least one solar cell for the supply of energy.

31. Weighing scale according to claim 17, wherein it is formed as a bathroom scale, letter scale or kitchen scale.

32. Weighing scale according to claim 17, wherein the load plate comprises an insertion device for a minicomputer, in particular a tablet PC, a smart phone or another flat minicomputer, or is formed by the minicomputer.
